(19) United States
(12) Patent Application Publication
(10) Pub. No.: US 2008/0051298 A1
(43) Pub. Date: Feb. 28, 2008

(54) Microarrays including probe cells formed within substrates and methods of making the same

(76) Inventors: Won-sun Kim, Gyeonggi-do (KR); Sung-min Chi, Gyeonggi-do (KR); Jung-hwan Hah, Gyeonggi-do (KR); Kyoung-seon Kim, Gyeonggi-do (KR); Sang-jun Choi, Seoul (KR); Man-hyoung Ryoo, Gyeonggi-do (KR)

Correspondence Address: MYERS BIGEL SIBLEY & SAJOVEC, PO BOX 37428, RALEIGH, NC, 27627, US

(21) Appl. No.: 11/891,767

(22) Filed: Aug. 13, 2007

(30) Foreign Application Priority Data
Aug. 24, 2006 (KR) 2006-80646

(51) Int. Cl. C40B 40/04; C40B 50/14

(52) U.S. Cl. 506/15; 506/30

(57) ABSTRACT

According to some embodiments of the invention, provided herein is a microarray comprising a substrate; a plurality of probe cells formed in the substrate, wherein at least one probe cell includes a linker; and a probe cell separation area. In addition, in some embodiments, the microarray may include a molecular probe coupled to the linker. Related methods are also described herein.

### CROSS-REFERENCE TO RELATED APPLICATION

This application is based on and claims priority Linder 35 U.S.C. §119 to Korean Patent Application No. 10-2006-0080646, filed on Aug. 24, 2006 in the Korean Intellectual Property Office, the disclosure of which is incorporated herein by reference in its entirety.

### FIELD OF THE INVENTION

The present invention relates to microarrays and methods of making the same.

### BACKGROUND OF THE INVENTION

Microarrays have been used in many biotechnological applications, including gene expression profiling, genotyping, detection of polymorphisms and mutations (e.g., SNP), analysis of proteins and peptides, and the screening, development and formulation of novel therapeutics. In typical molecular probes used currently, a plurality of probe cells is formed by optically activating a particular portion of an upper surface area of a substrate via the application of light (e.g., UV light) and then coupling molecular probes in situ to the optically activated area.

However, during optical activation, masks used to selectively irradiate portions of the substrate may become misaligned, undesirably activating part of the substrate that is meant to remain inactivated. Therefore, molecular probes may couple to portions of the substrate that should desirably remain inactive. Consequently, hybridization data for a target sample may be difficult to analyze due to a relatively low SNR.

Furthermore, as the size of the information to be analyzed using microarrays continues to decrease, e.g., to the level of a nucleotide, the design rule for probe cells may desirably be reduced from tens of μm to several μm. Accordingly, a lower SNR may adversely affect the accuracy of data analysis.

### SUMMARY OF THE INVENTION

According to some embodiments of the invention, provided herein is a microarray that includes a substrate; a plurality of probe cells formed in the substrate, wherein at least one probe cell comprises a linker; and a probe cell separation area. In addition, in some embodiments, the microarrays may include a molecular probe coupled to the linker.

In some embodiments, each probe cell is physically separated by a probe cell separation area. Furthermore, in some embodiments, at least one probe cell may comprise at least one material selected from the group consisting of a silicon oxide, a silicon nitride, a metal oxide, a siloxane, and a polymer. In addition, in some embodiments, at least one probe cell may comprise a flat upper surface, while in some embodiments, at least one probe cell may comprise a three-dimensional upper surface.

In some embodiments of the invention, the substrate may comprise silicon and/or glass, and a surface of the probe cell separation area may be an exposed surface of the substrate.

In further embodiments of the invention, the linker may comprise a silane and/or a siloxane group. Furthermore, in some embodiments, the linker may comprise a first linker coupled to the molecular probe via at least one additional linker.

Also provided according to some embodiments of the invention are methods of fabricating microarrays, which include forming a plurality of trenches in a substrate; forming a film on the substrate; and planarizing the film to form a plurality of probe cells, wherein at least one probe cell comprises a linker. In some embodiments, the planarizing is performed using an etch-back process and/or a chemical mechanical polishing (CMP) process. In some embodiments, the forming of the plurality of trenches may comprise forming a photoresist pattern on the substrate. Furthermore, in some embodiments, forming the plurality of trenches may comprise performing anisotropic etching using the photoresist pattern as a mask.

In some embodiments of the invention, methods of fabricating a microarrays may further comprise applying a linker solution to the substrate after planarizing the film, to obtain the linker. Moreover, in some embodiments, applying the linker solution may comprise spin coating the substrate with the linker solution; spin drying the substrate to remove unreacted linker solution; and baking the substrate. In some embodiments, at least one of the spin coating and the spin drying may be performed at a speed in a range of about 50 to about 5000 rpm. Furthermore, in some embodiments, the baking may be performed at a temperature in a range of about 100° C. to about 140° C.

In additional embodiments of the invention, the fabrication of the microarrays may comprise coupling at least one probe cell to a molecular probe. Furthermore, in some embodiments, each probe cell of the microarray may be coupled to a different molecular probe. Moreover, in some embodiments, the molecular probe may be coupled to the probe cell via a first linker. In some embodiments, the molecular probe may be coupled to the probe cell via at least one additional linker interposed between the first linker and the molecular probe.

Furthermore, in some embodiments, provided herein is a microarray that includes a substrate, a plurality of trenches recessed into the substrate, wherein the plurality of trenches comprises at least one probe cell, and wherein an upper surface of the at least one probe cell is at the same level or lower than an upper surface of the substrate. In some embodiments, the upper surface of the at least one probe cell may be flat, while in other embodiments, the upper surface may include a three-dimensional surface. Additionally, in some embodiments, the upper surface of the at least one probe cell and the upper surface of the substrate may be planarized so that the upper surface of the at least one probe cell is at the same level as the upper surface of the substrate.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are arrangements of probe cells of a microarray according to some exemplary embodiments of the present invention;

FIG. 2 is a cross-sectional view of a microarray including probe cells formed in a substrate according to some exemplary embodiments of the present invention;

FIGS. 3A and 3B are arrangements of probe cells of a microarray according to some exemplary embodiments of the present invention;

FIG. 4 is a cross-sectional view of a microarray including probe cells formed in a substrate according to some exemplary embodiments of the present invention;

FIGS. 5A to 5H are cross-sectional views of intermediate structures created in the process of fabricating the microarray of FIG. 2, according to some exemplary embodiments of the present invention; and

FIGS. 6A and 6B are cross-sectional views of intermediate structures created in the process of fabricating the microarray of FIG. 4, according to some exemplary embodiments of the present invention.

### DETAILED DESCRIPTION OF EMBODIMENTS OF THE INVENTION

It is to be understood that the terminology used herein is for the purpose of describing particular embodiments only, and is not intended to be limiting. In the present invention, it must be noted that, as used in the specification and the appended claims, the singular forms include plural referents unless the context clearly dictates otherwise. For example, a “cell” can mean a single cell or a multiplicity of cells. Furthermore, the terms “comprises” and/or “comprising,” as used herein, mean that the constituent, step, operation and/or element mentioned in the present invention does not exclude the presence or addition of one or more other constituents, steps, operations and/or elements. In addition, the term “and/or” means each of the items mentioned below and combinations thereof Furthermore, reference should be made to the drawings, in which the same reference numerals are used throughout the different drawings to designate the same or similar components.

In addition, the embodiments of the present invention are described with reference to sectional views and schematic views provided as ideal illustrations of the present invention. As such, the type of illustration may vary depending on the fabrication technique and/or allowable error. Thus, the embodiments of the present invention are not limited to the specific shapes shown in the drawings but include changes in shape that depend on the fabrication process. Furthermore, it is to be understood that the constituents depicted in the individual drawings might be illustrated as being slightly larger or smaller in consideration of convenience of description.

According to some embodiments of the invention, provided is a microarray that includes a substrate; a plurality of probe cells formed in the substrate, wherein at least one probe cell comprises a linker; and a probe cell separation area. The “probe cell” is a defined area of the microarray that includes a functional group that may act as a linker or is formed of a material that provides a functional group that can act as a linker once the material is treated by a surface treatment such as ozone, acid and/or base. Each probe cell may be isolated from the other probe cells in the microarray by a probe cell separation area. In addition, in some embodiments, the microarray may include a molecular probe coupled to the linker. The term “molecular probe,” as used herein, refers to a molecule attached to the probe cell. Non-limiting examples of a molecular probe of this invention include DNA, RNA, protein, peptide, antibody fragments, ligands, small molecules, antibody, tissue compounds, chemical compounds, and the like, that can interact directly or indirectly with a target sample to, e.g., identify the sample and/or characteristics thereof. Thus, a microarray, as used herein, can be any microarray known to those of skill in the art, e.g., DNA microarrays (also referred to as DNA chips or gene chips), RNA microarrays, oligonucleotide microarrays, protein microarrays, peptide microarrays, tissue microarrays, antibody microarrays and/or small molecule microarrays. In particular embodiments, the microarray is an oligonucleotide microarray.

In the microarrays provided in embodiments of the invention, a plurality of probe cells may be present in the substrate of the microarray and one, more than one but less than all, or all of the probe cells of the microarray may comprise a molecular probe. The molecular probe can be the same in one probe cell, in more than one but less than all, or in all the probe cells of a given microarray. Furthermore, the molecular probe may be different in some or each of the probe cells of a given microarray, such that multiple molecular probes may be present in the respective probe cells of a microarray of an embodiment of the invention, in any combination, any pattern, any arrangement and in any ratio or percentage relative to one another.

Furthermore, in a single probe cell comprising a molecular probe, the molecular probe may be of a single type (e.g., all are identical) or of different types (e.g., each or some of the molecular probes in a probe cell are different from one another). For example, in some embodiments, a first probe cell may comprise a plurality of oligonucleotide probes, some or all of which are different from one another. In some embodiments, the same microarray may also comprise a second probe cell comprising a plurality of molecular probes that may be oligonucleotides or other types of molecular probes (e.g., small molecules).

The term “coupling” or “coupled,” as used herein, is meant to signify the connection, linking, conjugation and/or attachment of the groups or molecules coupled. Such coupling may occur, e.g., via covalent and/or non-covalent interactions.

Hereinafter, a detailed description will be given of some of the embodiments of the present invention with reference to the appended drawings.

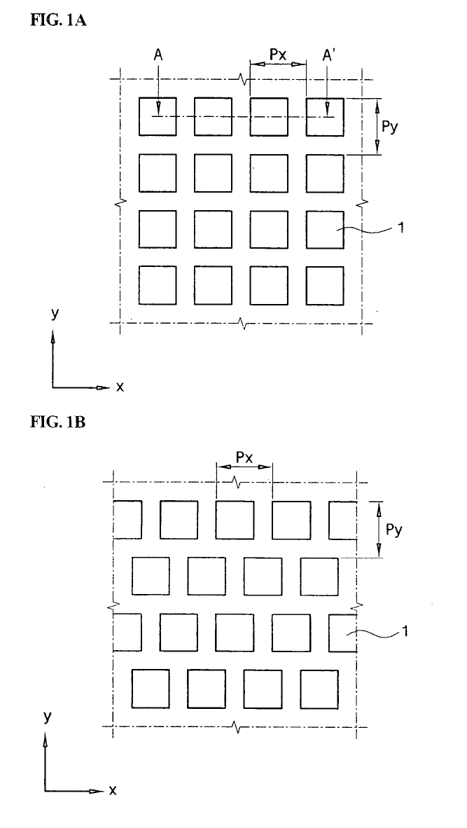

FIGS. 1A and 1B illustrate arrangements of the probe cells of a microarray that may be used in some embodiments of the present invention.

As shown in FIG. 1A, in some embodiments, a plurality of probe cells 1 are provided in the form of a matrix in a row direction and a column direction. Specifically, the probe cells are arranged at a first pitch Pₓ and a second pitch P_{y} in the x-axis and y-axis directions, respectively. Although the first pitch Pₓ and the second pitch P_{y} are shown as being identical in FIG. 1A, the arrangement of the probe cells may vary depending on the requirements. Furthermore, although the cell size is depicted as being uniform, in some embodiments, the microarray may include probe cells of different sizes. In addition, the probe cells in FIG. 1A are depicted as being square, but if suitable, other probe cell shapes may also be used.

As shown in FIG. 1B, in some embodiments, although the probe cells 1 of the odd numbered lines and the probe cells 1 of the even lines are both arranged at a predetermined pitch Pₓ, the probe cells 1 in the even numbered lines may be staggered in the row direction with respect to the probe cells in the odd numbered lines. Consequently, in some embodiments, the probe cells in the odd numbered lines may be symmetrical to each other and the probe cells in the even numbered lines may be symmetrical to each other, but the probe cells 1 in the odd numbered lines may be non-symmetrical to the probe cells 1 in the even numbered lines.

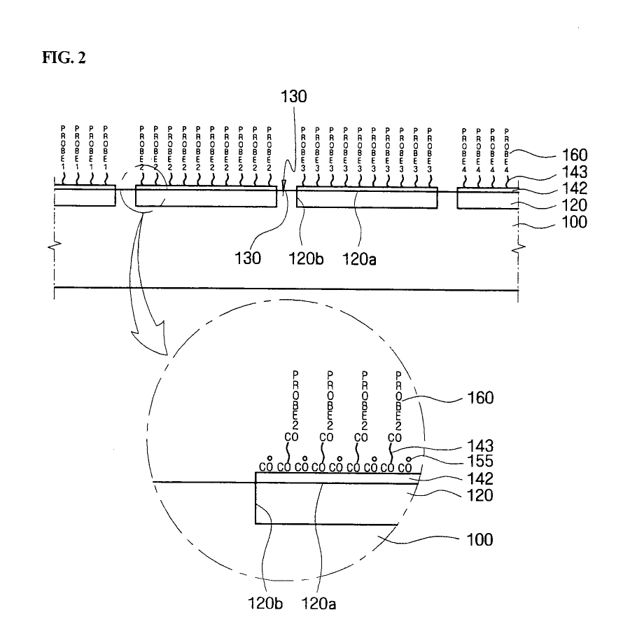

FIG. 2 is a cross-sectional view illustrating a microarray such as that depicted in FIG. 1A or 1B.

As shown in FIG. 2, microarrays according to some embodiments of the present invention may be composed of probe cells 120, which are physically separated by a predetermined area of the substrate 100. Therefore, the microarrays may include a probe cell separation area 130 that physically separates the probe cells 120. The probe cell separation area 130 is desirably unable to sufficiently couple with a molecular probe 160 and thus may be inactive.

In some embodiments of the invention, the physical separation of the probe cells 120 can be achieved by filling trenches (or other suitable deformations in the substrate) formed in the substrate 100 with a film in order to form the probe cells. In this way, because the trenches formed in the substrate 100 are filled with the film for the probe cells, the side wall 120b of the probe cell 120 may be inactive, and so may not be able to sufficiently couple to a molecular probe 160. Thus, even if the intervals between the probe cells 120 are relatively small, cross-talk between the adjacent probe cells may be reduced or eliminated.

In some embodiments of the invention, the upper surface of the probe cells 120a is at the same level or lower than the level of an upper surface of the substrate 100. For example, in some embodiments, the upper surface of the probe cells 120a and the upper surface of the substrate 100 have been planarized such that the upper surface of the probe cells 120a is the same as the upper surface of the substrate 100.

The substrate 100 is desirably formed of a material having minimal non-specific bonding to a molecular probe during the conditions of testing (e.g., hybridization). Additionally, in some embodiments, the substrate 100 may be formed of a material that is transparent to radiation such as visible and/or UV light. In some embodiments of the invention, the substrate may include a flexible substrate. Exemplary flexible substrates include, but are not limited to, nylon and nitrocellulose membranes and plastic films, as well as combinations thereof. In some embodiments, the substrate may include a rigid substrate. Exemplary rigid substrates include, but are not limited to, silicon and a transparent glass, such as soda lime glass, as well as combinations thereof. Silicon substrates and transparent glass substrates have been shown to result in the formation of relatively few non-specific bonds during hybridization. In addition, in the case of the transparent glass substrate, the substrate may be transparent to visible and/or UV light and therefore may be advantageous in the detection of fluorescent material. Moreover, silicon and transparent glass substrates may be favorable for various thin film preparation and photolithographic processes established in the field of semiconductor fabrication. Thus, in some embodiments, the probe cell separation area 130 may correspond to the exposed surface of a silicon or transparent glass substrate.

According to some embodiments of the invention, the probe cell 120 may include a material that is not substantially hydrolyzed under conditions of analysis of hybridization, e.g., in contact with phosphate or a Tris buffer with a pH in a range of about 6 to about 9. In addition, the probe cell 120 may include a material that may form a film and/or a pattern on the substrate 100, such as materials used in the fabrication of semiconductors or liquid crystal displays (LCDs). Furthermore, the probe cell 120 may be formed of a material that provides a functional group that can act as a linker 142 or may be formed of a material that provides a functional group that can act as a linker 142 once treated by a surface treatment such as ozone, acid and/or base. The functional group that can act as a linker 142 may be any suitable functional group that can act as a starting point for organic synthesis, either via covalently or non-covalently bonded interactions. Therefore, the functional group is not limited as long as it can be coupled with the at least one additional linker 143 and/or a molecular probe 160. Thus, for example, the probe cell 120 may include a silicon oxide, such as a PE-TEOS; an HDP oxide; a P-SiH₄ oxide; a thermal oxide; a silicate, such as hafnium silicate and/or zirconium silicate; a silicon nitride; a metal oxide; a siloxane; and/or a polymer, such as polyacrylate, polystyrene, polyvinyl, copolymers and/or mixtures thereof, and any combination thereof.

In some embodiments of the invention, the linker 142 may interact, for example, via hybridization, with a molecular probe 160, and so may include a functional group that can directly couple the probe cell 120 to the molecular probe 160 and/or a test sample. Therefore, in some embodiments, the linker 142 may be long enough to enable suitable interaction between the probe cell and a target sample. In particular embodiments, the length of the linker 142 is in a range of about 6 to about 50 atoms, but in some embodiments, longer or shorter lengths of the linker 142 may be desirable. The linker 142 may also include a functional group that may be indirectly coupled to the molecular probe 160 and/or a target sample. The term “indirect coupling” refers to a coupling between the linker 142 and the molecular probe 160 or target sample by interposing at least one additional linker 143 between the first linker 142 and the molecular probe 160 and/or a test sample, as shown in FIG. 2. In the case where the first linker 142 is connected to the molecular probe 160 via the at least one additional linker 143, the first linker 142 may include a coupling group for coupling to the probe cell 120 and a functional group for coupling to the at least one additional linker 143. Although the indirect Coupling via the at least one additional linker 143 is shown in FIG. 2, as described above, the first linker 142 may be directly coupled to the molecular probe 160 and/or a target sample in the absence of the at least one additional linker 143, depending on the properties thereof. In this case, the linker 142 may include a coupling group for coupling to the probe cell 120 and a functional group for directly coupling to the molecular probe 160 and/or a target sample.

Additionally, the linker 142 may include a protecting group for storage purposes. As is known to those of skill in the art, a protecting group can minimize or prevent the protected portion of a molecule from reacting. As such, when desired, the linker 142 may also be deprotected, whereby the protecting group is removed, to thus allow the previously protected portion of the linker 142 to participate in a reaction such as coupling to a molecular probe 160, a test sample and/or an at least one additional linker 143. For example, an acid labile or photolabile protecting group may be attached to the functional group of the linker 142 in order to protect such functional group, and can then be removed before coupling in a photolithographic synthesis in situ, or before coupling to a synthetic molecular probe 160 or a test sample, thereby exposing the functional group. As one of skill in the art will understand, the at least one additional linker 143 may also be protected and deprotected in a similar manner.

As an example, FIG. 2 depicts an embodiment wherein a Si(OH) group is exposed on a probe cell 120, e.g, a probe cell 120 formed from a silicon oxide film, a silicate, a silicon oxynitride film and/or a spun-on siloxane film. In such a case, the probe cell 120 may include a silane or siloxane-based linker that includes a coupling group able to form a siloxane (Si—O) bond via a reaction with Si(OH) and a functional group able to form an organic coupling reaction with the at least one additional linker 143, the molecular probe 160 and/or target sample. Exemplary coupling groups include —Si(OMe)₃, —SiMe(OMe)₂, —SiMeCl₂, —SiMe(OEt)₂, —SiCl₃, and —Si(OEt)₃. Exemplary functional groups include an organic hydroxyl group, an organic amine group, and the like. As such, exemplary linkers include alkoxy silane materials including a hydroxyl and/or an amine group; mixtures of active silane materials having a hydroxyl and/or an amine group and inactive silane materials having no functional group; and/or alkoxy silane materials capable of producing a hydroxyl and/or an amine group upon activation of the material by light, heat and/or acids. Exemplary specific linker materials include, but are not limited to, N-(3-(triethoxysilyl)-propyl)-4-hydroxybutyranide), N,N-bis(hydroxyethyl)aminopropyl-triethoxysilane, acetoxypropyl-triethoxysilane, 3-glycidoxy propyltlimethoxysilane, poly(dimethylsiloxane), the silicon compounds disclosed in WO 00/21967 and the materials disclosed in U.S. Pat. Nos. 6,989,267 and 6,444,268 (the relevant portions of each of which are incorporated herein by reference), as well as any combination thereof.

As another example, in an embodiment wherein the probe cells 120 are formed of a polymer, exemplary linkers 142 may include silane and/or siloxane-based linkers that include an acrylic, styryl and/or vinyl group, in any combination, as the coupling group.

In some embodiments, the at least one additional linker 143 may be interposed between the linker 142 and the molecular probe 160. The at least one additional linker (e.g., a second linker) 143 may be, for example, a material which has a coupling group capable of reacting with the functional group of the linker 142 and also includes a functional group to be coupled with a molecular probe 160 or a monomer for in situ synthesis, e.g., via decomposition by light, heat and/or acids. As depicted in FIG. 2, as with the first linker 142, an exemplary functional group for the at least one additional linker 143 is a hydroxyl moiety. As described in reference to the functional group of the first linker, in some embodiments, other functional groups may be used as appropriate. In addition, the at least one additional functional group may be protected for storage. The phrase “at least one additional linker” denotes that the at least one additional linker may be composed of one or more linker subunits.

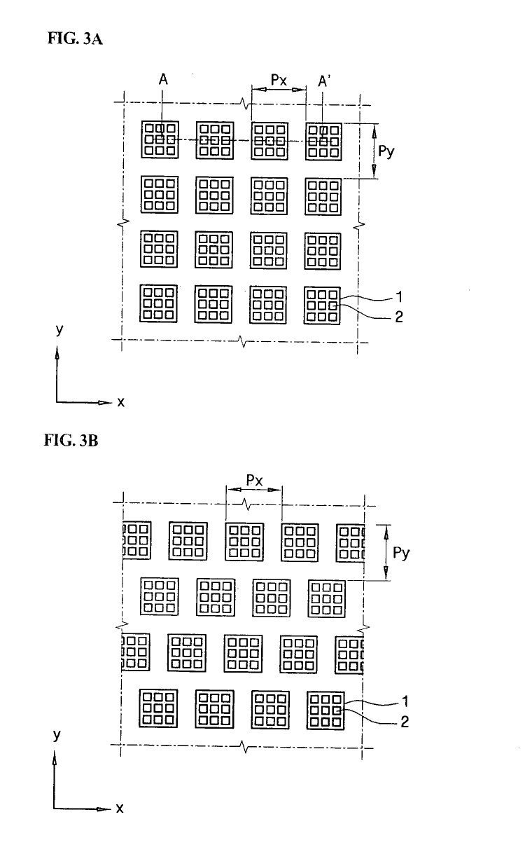

FIGS. 3A and 3B illustrate arrangements of probe cells that are substantially the same as those depicted in FIGS. 1A and 1B, respectively, with the exception that a pattern 2 including a plurality of grooves is provided in the probe cell 1 so as to cause the surface of the probe cell 1 to be three-dimensional.

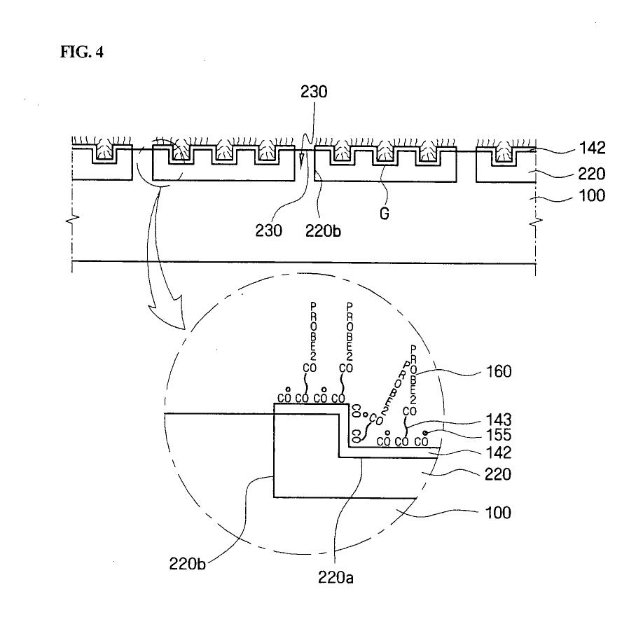

FIG. 4 is a cross-sectional view of a microarray, such as those depicted in FIG. 3A or 3B.

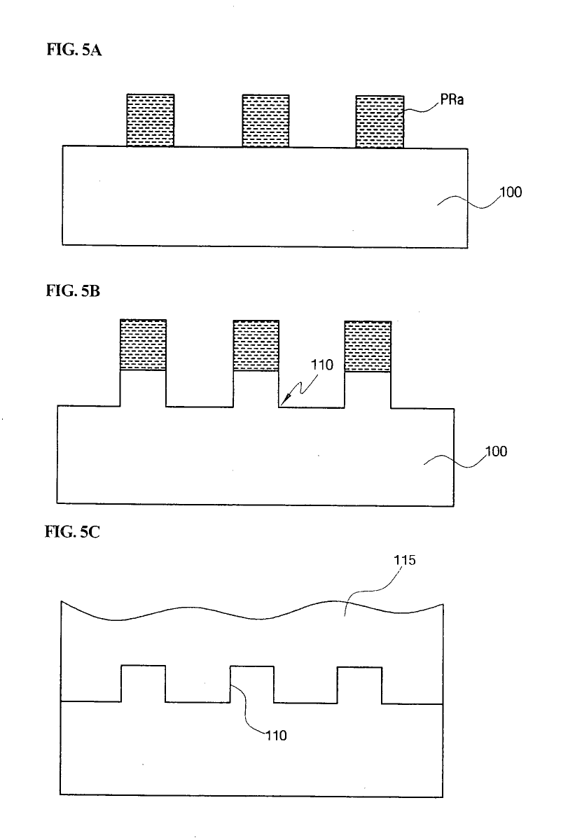

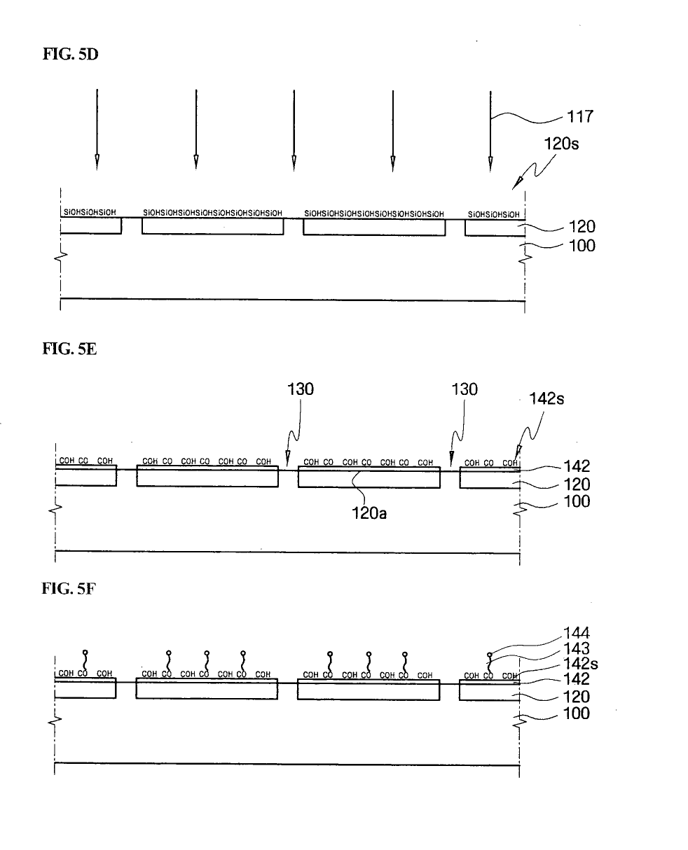

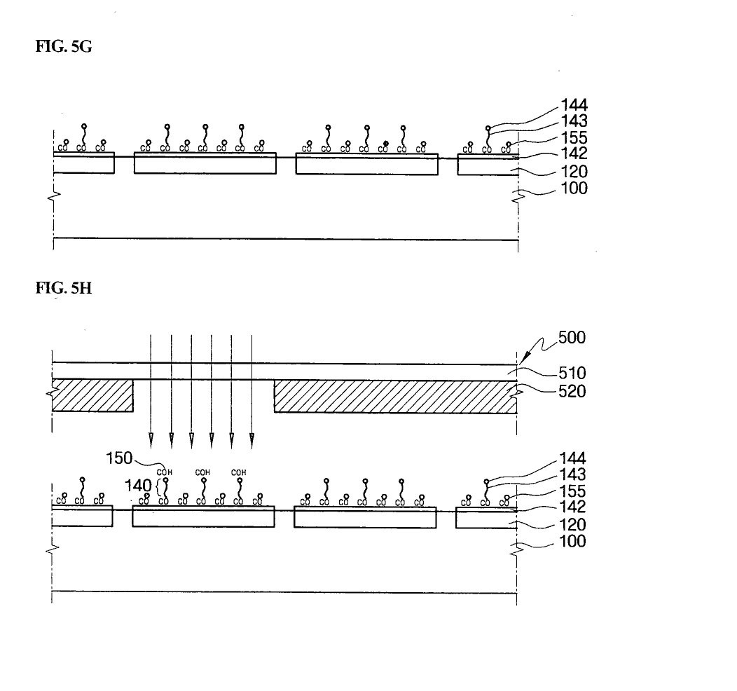

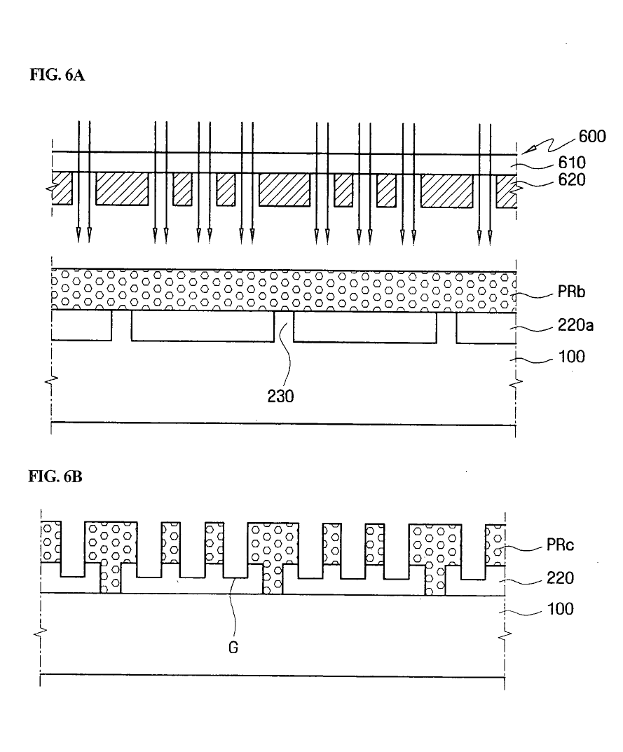

Although the microarray depicted in FIG. 4 is similar to the microarray depicted in FIG. 2, the probe cell 220 depicted in FIG. 4 includes a three-dimensional surface, which may increase the surface area available to couple to the molecular probes 160, as compared to planar microarray; to which the same design rule is applied. In other words, if the microarray depicted in FIG. 4 is formed using the same design rule as the microarray depicted in FIG. 2, the number of molecular probes 160 that can be coupled to the cell probes may be increased. Therefore, microarrays including three-dimensional probe cells such as those depicted in FIG. 4 may increase the detection strength, which may be advantageous as the design rule is decreased. As used herein, the term “three-dimensional surface” is meant to indicate that the surface of the probe cell 220 is not planar, but instead is formed into a three-dimensional structure, for example, by including at least one groove G in the probe cell 220. Any type of three-dimensional structure may be provided, without being limited to grooves G, as long as a three-dimensional surface is formed. FIGS. 5A to 5H and FIGS. 6A and 6B illustrate a method of fabricating a microarray according to some embodiments of the present invention.

FIGS. 5A to 5H are cross-sectional views of intermediate structures created during the fabrication of a microarray, e.g., the microarray depicted in FIG. 2.

In FIG. 5A, a photoresist pattern PRa is formed on a substrate 100. The photoresist pattern PRa is provided on the area of the substrate 100 that will form the probe cell separation area.

In FIG. 5B, using the photoresist pattern PRa as a mask, the substrate 100 is etched to a desired depth, thus forming trenches 110. Exemplary etching processes include, but are not limited to, anisotropic etching and/or dry etching.

In FIG. 5C, a film 115 for forming the probe cells is provided on the substrate 100 to thus fill the trenches 110.

The film 115 may be formed by any suitable method, which would be well-known to those of skill in the art. For example, in some embodiments, the film may include a silicon oxide, such as PE-TEOS; an HDP oxide; a P—SiH₄ oxide; a thermal oxide; a silicate, such as hafnium silicate or zirconium silicate; a silicon oxynitride; a spun-on siloxane film; and/or a polymer film, such as polyacrylate, polystrene, polyvinyl, copolymers thereof; and/or mixtures thereof; as well as any combination thereof In some embodiments, the film may be formed by a process used in the field of fabrication of semiconductors or LCDs, e.g., CVD (Chemical Vapor Deposition), SACVD (Sub-Atmospheric CVD), LPCVD (Low Pressure CVD), PECVD (Plasma Enhanced CVD), sputtering and/or spin coating.

In some embodiments, the film 115 is formed at the same level or lower than the level of an upper surface of the substrate 100. In some embodiments, the probe cells are formed such that the upper surface of the probe cell 120a is the same level as an upper surface of the substrate 100 by using planarization techniques. For example, in FIG. 5D, the film 115 is subjected to planarization 117 to thus form the probe cells 120 in the substrate 100. Exemplary planarization techniques include, but are not limited to, etch-back processes and/or chemical mechanical polishing (CMP) processes. For example, in some embodiments, an etch-back process is used to realize planarization via etching of the entire surface without the use of a photoresist pattern, and a CMP process is performed by placing the substrate on a polishing pad and realizing physical and chemical planarization using a polishing agent. In the case of using a CMP process, in some embodiments, the substrate 100 may be used as an etch stop layer, and in some embodiments, a silicon nitride film, Which is placed on the substrate, may serve as the etch stop layer.

In some embodiments of the invention, a plurality of functional groups may be exposed on the surface 120s of the planarized probe cells 120. As an example, a probe cell 120 formed of a silicon oxide film is described in FIGS. 5D through 5H. For a probe cell 120 formed of a silicon oxide film, a SiOH group capable of being coupled with the molecular probe may be exposed on the Surface 120s of the silicon oxide film.

In FIG. 5E, a linker solution (not shown) may be applied to the substrate 100. The linker solution may be a solution including a molecule that can react, e.g., with the Si—OH group to form the linker 142 in the probe cell 120. In some embodiments, the application of the linker solution includes applying a linker solution to the substrate 100 via a) spin coating; b) spin drying the unreacted linker solution; and c) baking the remaining linker solution. In some embodiments, upon spin coating, the linker solution may be applied as a relatively thin film, so that the linker 142 may form a monolayer, e.g., having a thickness of about 100 nm or less, which may contribute to a relatively low SNR of the microarray. In some embodiments, at least one of the steps of spin coating and spin drying may be performed at a speed in a range of about 50 to about 5000 rpm. In some embodiments, the spin coating process may be performed at fewer rpm than the spin drying process, or may be performed without spinning. In some embodiments, the substrate is baked at a temperature in a range about 100° C. to about 140° C.

Exemplary linker solutions include a silane-based linker solution or a siloxane-based linker solutions in which the functional group of the linker is more reactive with the molecular probe or test sample than with the SiOH group of the probe cell 120. In addition, it is desirable, in some embodiments, that the linker 142 does not sufficiently couple to the surface of the substrate 100 corresponding to the probe cell separation area 130.

On the surface 142s of each of first linkers 142, a functional group (e.g., —COH) having greater coupling reactivity to the molecular probe than to the SiOH of the probe cell 120 is exposed.

In FIG. 5F, at least one additional linker 143, which may include a photolabile protective group 144 attached thereto, is coupled to the —COH group of the surface 142s of the first linker 142. The at least one additional linker 143 preferably includes a material of sufficient length for interacting with a target sample and/or molecular probe. An example one additional linker 143 includes, but is not limited to, phosphoramidite with a photolabile protecting group attached thereto. The photolabile protecting group 144 may be any suitable protection group including, e.g., nitro aromatic compounds such as o-nitrobenzyl derivatives and/or benzyl sulfonyl. Specific examples of photolabile protective groups 144 include 6-nitroveratryloxycarbonyl (NVOC), 2-nitrobeiizyloxycarbonyl (NBOC), and α,α-dimethyl-dimethoxybenzyloxycarbonyl (DDZ) and combinations thereof. Therefore, in some embodiments, a linker, in which the functional group to be coupled with the molecular probe 160 is protected by the photolabile protective group 144, and including the first linkers 142 and at least one additional linker 143 may be used.

FIG. 5G illustrates that in some embodiments, a plurality of functional groups may be exposed but not coupled to the at least one additional linker 143, and that these functional groups may be capped to be inactive. Such capping may be performed by using a capping group 155, e.g., by enabling the acetylation of the functional group (e.g., SiOH or COH).

In FIG. 5H, for in situ synthesis of the molecular probe 160, the functional group 150 may be exposed by deprotecting the photolabile protective group 144 from the terminal end of the at least one additional linker 143, e.g., by using a mask 500 that exposes the desired probe cell 120 to radiation.

Although not shown in FIG. 5H, the exposed functional group 150 may then be coupled to a molecular probe 160. In some embodiments, the molecular probe may be an oligonucleotide probe, and the probe may be synthesized through in situ photolithography. In some embodiments, the exposed functional group 150 may then be coupled with a nucleoside phosphoramidite monomer having a photolabile protective group, or may be coupled with a nucleotide that has a photolabile protective group and is amidite activated, followed by inactively capping the non-coupled functional group, and then oxidizing a phosphite triester structure to convert it into a phosphate structure. In this way, a series of processes that include deprotecting the desired probe cell 120; coupling it with a monomer having a desired sequence; capping the functional group that is not coupled in order to inactivate it; and performing the oxidation to thus form a phosphate structure, may be sequentially repeated in order to synthesize an oligonucleotide probe 160 having the desired sequence on the probe cell 120.

FIGS. 6A and 6B are cross-sectional views of intermediate structures created in the process of fabricating a microarray, e.g., the microarray depicted in FIG. 4, according to some embodiments of the present invention.

Since the processes and materials depicted in FIGS. 6A and 6B are substantially the same as those described with respect to FIGS. 5A to 5D, a description thereof is omitted, and subsequent processes are described below.

In FIG. 6A, a photoresist film PRb is applied on a substrate 100 having probe cells 220 and a probe cell separation area 230, and is then exposed to radiation from a profile projector through a mask 600 manufactured according to the groove pattern 2, e.g., according to a groove pattern shown in the arrangements of FIGS. 3A and 3B.

In some embodiments, the mask 600 may be a checkerboard-type mask that includes a transparent substrate 610 and light-shielding patterns 620, which are formed on the transparent substrate 610 and define probe cell regions. As one of skill in the art will understand, the shape(s) of the light-shielding patterns 620 may vary according to the type of the photoresist layer PRb. In FIG. 6B, the exposed photoresist film PRc is developed to thus form a photoresist pattern PRc defining the groove pattern. The resulting pattern photoresist pattern PRc can then act as an etching mask as an etching process is performed, thereby forming probe cells 220 having a three-dimensional surface due to internally formed grooves G.

The subsequent processes are substantially similar to the processes described with respect to FIGS. 5E to 5H, and thus a description thereof is omitted.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A microarray comprising:
a substrate;
a plurality of probe cells formed in the substrate, wherein at least one probe cell comprises a linker; and
a probe cell separation area.

2. The microarray of claim 1, further comprising a molecular probe coupled to the linker.

3. The microarray of claim 1, wherein each probe cell is physically separated by the probe cell separation area.

4. The microarray of claim 1, wherein the linker comprises a silane and/or a siloxane group.

5. The microarray of claim 1, wherein at least one probe cell comprises at least one material selected from the group consisting of a silicon oxide, a silicon nitride, a metal oxide, a siloxane, a polymer and any combination thereof.

6. The microarray of claim 1, wherein at least one probe cell comprises a flat upper surface.

7. The microarray of claim 1, wherein at least one probe cell comprises a three-dimensional upper surface.

8. The microarray of claim 1, wherein the substrate comprises silicon and/or glass, and wherein a surface of the probe cell separation area is an exposed surface of the substrate.

9. The microarray of claim 2, wherein the linker comprises a first linker coupled to the molecular probe via at least one additional linker.

10. A method of fabricating a microarray, comprising:
forming a plurality of trenches in a substrate;
forming a film on the substrate; and
planarizing the film to form a plurality of probe cells, wherein at least one probe cell comprises a linker.

11. The method of claim 10, wherein the planarizing is performed using an etch-back process and/or a chemical mechanical polishing (CMP) process.

12. The method of claim 10, wherein at least one probe cell comprises a material selected from the group consisting of a silicon oxide, a silicon nitride, a metal oxide, a siloxane, a polymer film and any combination thereof.

13. The method of claim 10, wherein forming the plurality of trenches comprises forming a photoresist pattern on the substrate.

14. The method of claim 13, wherein forming the plurality of trenches comprises performing anisotropic etching using the photoresist pattern as a mask.

15. The method of claim 10, further comprising applying a linker solution to the substrate after planarizing the film to obtain the linker.

16. The method of claim 15, wherein applying the linker solution comprises:
spin coating the substrate with the linker solution;
spin drying the substrate to remove unreacted linker solution; and
baking the substrate.

17. The method of claim 15, wherein the linker solution comprises a silane and/or a siloxane group.

18. The method of claim 16, wherein at least one of the spin coating and the spin drying is performed at a speed in a range of about 50 to about 5000 rpm.

19. The method of claim 16, wherein the baking is performed at a temperature in a range of about 100° C. to about 140° C.

20. The method of claim 10, wherein at least one probe cell comprises a flat upper surface or a three dimensional upper surface.

21. The method of claim 10, wherein the substrate comprises silicon and/or glass and wherein a surface of the probe cell separation area is an exposed surface of the substrate.

22. The method of claim 10, further comprising coupling at least one probe cell to a molecular probe.

23. The method of claim 22, wherein each probe cell of the microarray comprises a different molecular probe.

24. The method of claim 22, wherein the molecular probe is coupled to the probe cell via a first linker.

25. The method of claim 24, wherein at least one additional linker is interposed between the first linker and the molecular probe.

26. A microarray comprising:
a substrate; and
a plurality of trenches recessed into the substrate, wherein the plurality of trenches comprises at least one probe cell, and
wherein an upper surface of the at least one probe cell is at the same level or lower than an upper surface of the substrate.

27. The microarray of claim 26, wherein each of the plurality of trenches comprises a probe cell.

28. The microarray of claim 26, further comprising a molecular probe coupled to a linker of the at least one probe cell.

29. The microarray of claim 26, wherein the upper surface of the at least one probe cell comprises a flat surface.

30. The microarray of claim 29, wherein the upper surface of the at least one probe cell and the upper surface of the substrate are planarized so that the upper surface of the at least one probe cell is the same level as the upper surface of the substrate.

31. The microarray of claim 26, wherein the upper surface of the at least one probe cell comprises a three-dimensional surface.

32. The microarray of claim 26, wherein the upper surface of the substrate is a probe cell separation area.

33. The microarray of claim 26, wherein the at least one probe cell comprises at least one material selected from the group consisting of silicon oxide, silicon nitride, a metal oxide, a siloxane, a polymer and any combination thereof.
